(19) United States
(12) Patent Application Publication
(10) Pub. No.: US 2019/0279125 A1
(43) Pub. Date: Sep. 12, 2019

(54) SYSTEM AND METHOD FOR SCHEDULING ACTIVITIES AND ASSOCIATED DESTINATIONS

(71) Applicants: John Rosinsky, Oakdale, PA (US); Domenic Rosinsky, Oakdale, PA (US); Tyler Pratte, Oakdale, PA (US)

(72) Inventors: John Rosinsky, Oakdale, PA (US); Domenic Rosinsky, Oakdale, PA (US); Tyler Pratte, Oakdale, PA (US)

(73) Assignee: JTM LLC, Oakdale, PA (US)

(21) Appl. No.: 16/018,153

(22) Filed: Jun. 26, 2018

Related U.S. Application Data
(60) Provisional application No. 62/639,227, filed on Mar. 6, 2018.

(51) Int. Cl. G06Q 10/02; G06F 17/30

(52) U.S. Cl. CPC G06Q 10/025; G06F 17/30241; G06Q 50/14; G06F 17/30554; G06F 17/3053

(57) ABSTRACT

A method for selecting a travel itinerary wherein a traveler first identifies their own set of preferred activities irrespective of a particular travel itinerary and thereafter compares their set of preferred activities to activities of established travel itineraries to identify the itinerary most favorable to the traveler's set of preferred activities.

### BACKGROUND OF THE INVENTION

### Field of the Invention

The presently disclosed invention relates to identifying activities according to selected interests and preferences and, based on activity selections, identifying a travel destination or travel itinerary that may optimize such interests and preferences.

### Discussion of the Prior Art

In the prior art, it has been customary for travelers to select a travel itinerary or destination and thereafter, based on that selection, attempt to identify activities that coordinate with the selected location or itinerary. Such travel can be by aircraft, ship, train, automobile or other transportation mode to single destinations or to multiple locations according to a set itinerary. As an example of such travel and without limitation, for a number of years various cruise companies have offered ocean cruises to various destinations that are commonly of interest to travelers. Such cruises offer a wide array of itineraries and destinations with the purpose of satisfying the interests and entertainment demands of a broad spectrum of travelers. During the development of the cruise industry, the emphasis has been on routing, destinations, ports-of-call, and on-board activities of the cruise ship. For example, a traveler may decide that they would like to cruise in the Caribbean Sea. Based on that routing, they could investigate the itinerary of various cruise ships that schedule travel in that area and, from the industry offerings, select a cruise ship according to factors such as cost, dates of travel, ports-of-call, and on-board activities. However, identifying various activities that were not directly available on-board the ship or through pre-arranged excursions were extremely limited or altogether absent.

Accordingly, there has been a need for a convenient and reliable way to identify activities that are available in various geographical locations irrespective of the particular means of transportation to or between those locations. For example, it is widely known that ocean cruises afford opportunities for various activities at ports-of-call. However, the range of such activities is bound by the offerings of the particular vessel and itinerary. The traveler does not have a readily available method for prioritizing a particular interest or group of interests and then, based on that interest set, selecting a cruise vessel that will maximize the availability of activities meeting those interests. For example, a traveler's primary interest may be in sport fishing and also in bicycling and, while they may be interested in traveling to or through a particular geographic region, they may not know precisely where and when those activities are available. As another example, a traveler who may be interested in the same set of excursions or activities may place a higher priority on the dates of travel than on the geographic region that is visited.

In the prior art, the traveler's choices were limited by priority to geographic region, dates of travel, and other variables that were controlled directly by one or more cruise lines. While the above examples pertain to cruises, the same difficulties and disadvantages have been generally even more acute in connection with other modes of transportation such as trains or aircraft for which the universe of available activities is even less defined.

Accordingly, there was a compelling need in the prior art for a method and system that would enable travelers to first prioritize one or more excursions and, based on that prioritized set of excursions, select a cruise that would optimize those excursions.

### SUMMARY OF THE INVENTION

The presently disclosed invention is directed to a method and system for selecting a preferred travel itinerary by giving priority to the traveler's preferred activities over activity sets that a travel company has previously established. In accordance with the disclosed invention, the traveler first identifies those activities that they most prefer according to one or more criteria. The preference criteria may include the geographical location, the date or time on which the activity occurs, or a class or category of the activity. The traveler selects and prioritizes their activities irrespective of the geographical location or time schedule of any cruise or other mode of travel or travel itinerary. Thereafter, the traveler's personal prioritized activities are correlated with respect to the established activity sets of various cruises or other travel modes that are arrayed according to selected factors such as the geographical location and/or the time schedule for the established itinerary. The degree of coincidence between the traveler's prioritized activities and activities made available by established travel itineraries of cruise lines or other travel companies is determined. The established travel itineraries are rated according to the degree of coincidence with higher geographical and temporal coincidence of the traveler's selected activities with the established travel itinerary supporting a higher rating. Established travel itineraries with the highest ratings correspond to itineraries with the greatest agreement with the traveler's preferred activities.

In accordance with the presently disclosed invention, the traveler inputs their preferences for activities into a computer that is configured to query an activity database. Activities in the data base are organized according to selected criteria such as geographical location, date or time, or a designated category type. Activities corresponding to the traveler's inputted preferences are reported from the database to the computer in accordance with the relative agreement between the activity criteria and the traveler's inputted activity preferences. The computer then compares the reported activities to activity sets that are available through established land, air or sea travel itineraries such as cruises. Travel itineraries that have the highest correlation with the traveler's inputted, preferred activities are then reported to the traveler as being the highest rated according to the traveler's activity preferences.

More preferably, the disclosed method compares the traveler's selected, prioritized, activities to travel itineraries that have at least one activity that corresponds to a selected, prioritized activity. For each respective itinerary, the number of activities that coincide geographically with the traveler's preferred, selected activities are identified. Each travel itinerary is then weighted in proportion to the number of ports-of-call on the travel itinerary multiplied by the number of categories of traveler-selected activities.

Still more preferably, in some cases, weighting of travel itineraries may be refined such as by using only the number of ports-of-call in the itinerary for which there is a coinciding traveler-selected activity. In some cases, the weighting also may be further refined by determining a match score such as, for example, by dividing the number of instances when at least one traveler-selected activity category coincides with an activity category at a port-of-call by the product of the number of ports-of-call times the number of categories of traveler-selected activities.

Other features and advantages of the presently disclosed invention will become apparent to those skilled in the art as the description of the presently disclosed invention proceeds.

### BRIEF DESCRIPTION OF THE DRAWINGS

A presently preferred embodiment of the disclosed invention is shown and described in the accompanying figures wherein:

FIG. 1 is a flow diagram that illustrates basic steps in connection with a presently preferred embodiment of the disclosed invention that relates to a cruise itinerary; and

FIG. 2 is a flow diagram that illustrates steps in connection with a presently preferred embodiment for determining an activity match score in accordance with the presently disclosed invention.

Other embodiments of the presently disclosed invention will become apparent to those skilled in the art as a description of a presently preferred embodiment of the invention proceeds.

### DESCRIPTION OF A PRESENTLY PREFERRED EMBODIMENT

The presently disclosed invention relates to the identification and selection of preferred activities by a traveler according to their personal preferences and interests. The invention is applicable across all modes of land, sea and air travel to a single destination or between multiple locations in a travel itinerary. As an example in which the mode of transportation is primarily by sea, a presently preferred embodiment herein described includes an application (herein “app”) that enables cruise travelers to optimize excursions or activities that are within their expressed, preferred field or fields of interest. Other examples in which transportation is by air or land are also applicable.

Specifically with regard to sea travel, the app enables a prospective cruise traveler to prioritize selected excursions and associate those excursions with one or more cruise offerings whose routing and scheduling will enable the traveler to optimize their participation in the excursions that they have identified.

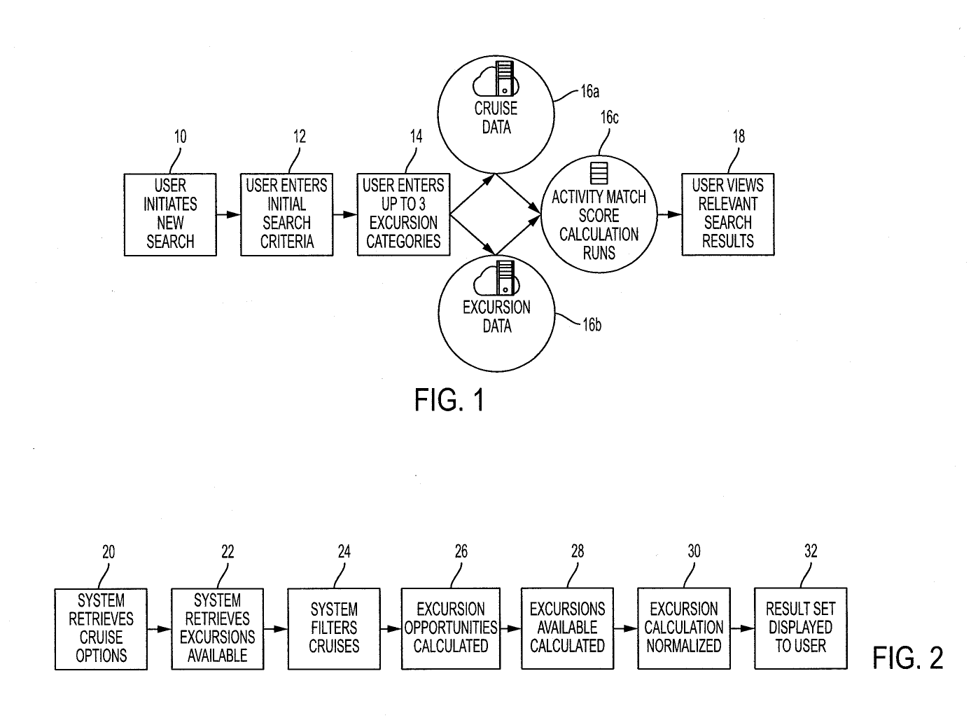

As illustrated in the flow diagram of FIG. 1, at step 10 the traveler opens the app and at step 12 and selects data elements within identified categories. In the example of the preferred embodiment, the selection categories may include: desired travel month; desired cruise region (Bahamas, Hawaii, South Pacific, South America, etc.); and departure port although additional or different selection categories could also be identified and offered. In the example of the preferred embodiment, the month of travel is a required field. The other fields need not be populated or answered. In other embodiments, alternative or additional fields can be substituted or offered.

After inputting selection for the initial fields (at least the month of travel) at step 12, the user may identify the types of excursions that they would like to experience as part of their itinerary at step 14. In the example of the preferred embodiment, all identified types of available excursions or activities are included in one of eleven categories. In the example of the preferred embodiment, at step 14 the search may be based on up to three categories. In other embodiments, the search may be based on more or fewer categories.

As further explained later herein, at steps 16a, 16b and 16c, the user may conduct a search of all excursions within any or all of the eleven categories. After selecting the desired categories for excursions or activities (at least one must be selected) at step 14 and conducting the search of those categories at steps 16a, 16b, and 16c, the user may view search results at step 18.

The search results at step 18 identify all vessels whose itinerary satisfies: (1) the initial conditions (such as location and date) that the user specified; and (2) afford at least one excursion or activity in at least one of the activity categories that the user identified. The user may view the search results or the user may choose to further limit or refine the search results through certain filters such as cost or other criteria. The user may also further limit or refine the search results by arranging the search results according to certain, selected priorities such as time of day, duration of the activity, or physical requirements of the activity. Based on the user's personal priorities and preferences, the user may then select a potential cruise that is most preferred in terms of satisfying their personal criteria.

Upon selecting a potential cruise, further details of that cruise may be published to the user. For example, the application may compile an itinerary that includes all ports-of-call that are scheduled for the selected cruise together with the excursions within each user-selected activity category that are available at each port.

While viewing the details of a cruise or sailing at step 18, the user may inspect other features of the cruise. In the example of the preferred embodiment, such features include browsing multiple activity options at each port city, viewing cabin appointments and pricing information, and viewing information concerning overall features of the vessel. Other viewing options may be provided in other embodiments. Additionally, the user may choose to book cruises and activities from this itinerary listing.

As a further example, in steps 16a, 16b, and 16c the app may evaluate the strength or propriety of the activity match by weighting the search results based on the availability of activities at each port-of-call and ordering the search results based on a selected default factor. For example, the search results may be presented in the order in which the highest weighted matches are listed first.

### Activity Match Score

FIG. 2 illustrates a flow diagram wherein the order of presentation (or “sort order”) of activity search results at step 18 initially may be based on an Activity Match Score and ordered from highest score to lowest score. The activity match score compiled in accordance with the presently disclosed invention is calculated based on the availability of activities in each of the categories that the user selects at step 14. The more options throughout the sailing itinerary for booking an activity that falls within a user-selected category, the higher the score. The highest rated Activity Match Scores correspond to those travel itineraries in which every single activity category that the user selects at step 14 is available at every port-of-call that is visited by the vessel during the cruise. Search results sorted in this way optimize the particular sailing that affords the user the highest correlation with those activities in which they have expressed an interest or preference. In this way, the search results may be sorted in accordance with the number and type of activity opportunities that most closely match the users expressed interests and priorities.

As further illustrated in FIG. 2, from the cruise data database that is shown in Step 16a of FIG. 1, at step 20 of FIG. 2 the application identifies cruises, that meet the month, geographical region, and departure port criteria that the traveler has identified in step 12. That data set establishes the baseline for the specific search results.

Next, from the database that is identified at step 16b of FIG. 1, at step 22 of FIG. 2 the application retrieves excursion data. The application then determines which excursions are available at each port-of-call along the travel itinerary for each cruise.

At step 24, the application eliminates from the data set those cruises for which there are no excursions in any category that the user identified at step 14 of FIG. 1.

At step 26, for each cruise that is not filtered out at step 24 the application determines the number of “excursion opportunities”—that is, the product of the number of ports-of-call on the cruise itinerary multiplied by the number of excursion categories that the user selected at step 14 of FIG. 1.

At step 28, for each cruise itinerary the application identifies the instances that at least one excursion in one of the categories that the user selected at step 14 of FIG. 1 is available at a port-of-call. No additional weighting is added for instances in which more than one excursion is available or in which excursions in more than one category are available at a single port-of-call.

At step 30, the application normalizes the scores of different cruises as to differences in itinerary length—that is, differences in the total number of ports-of-call between different cruises. To do this, for each itinerary the application divides the number of instances in the itinerary that at least one excursion in one of the user categories is available as determined in step 28 by the total number of ports-of-call in that itinerary. This normalized score is the “activity match score” (“AMS”) for each cruise itinerary. The highest possible AMS for any cruise is “1.” The “1” AMS score occurs when, at each port-of-call on the cruise itinerary, there is an excursion that corresponds to at least one of the categories that the use selected at step 14 of FIG. 1.

The search result and AMS score is displayed to the user at step 32. In one embodiment, the search result for each cruise is displayed in descending order of AMS score. In one embodiment, the search result may be displayed with the AMS score as a ten-unit bar chart in which the maximum AMS score (“1”) is displayed by all ten units appearing in the bar graph. AMS scores of less than “1” are displayed with the number of bar chart units displayed being rounded to the nearest tenth. For example, an AMS score that is rounded to 0.7 would be represented by a bar graph with seven units and an AMS score that is rounded to 0.3 would be represented by a bar graph with three units.

The Activity Match Score is automatically calculated for each search result. The search coordinates various activity schedules and inter-activity travel times to avoid schedule conflicts. The search also filters out activities that are too distant from the ship's scheduled ports-of-call to allow appropriate travel times to and from the ship. The Activity Match Score also may be weighted in response to user reviews that that are submitted directly or that are supported on third-party web sites. In some embodiments, the user also may choose to sort selected activities according to factors of cost, dates of travel, or length of travel, either alone or in combination together, or in combination with the Activity Match Score.

### Data Flow

The presently disclosed invention directly associates commercially available activities with cruise itineraries. In the prior art, there was no direct relation of activities (such as is available from Shorefox™) to cruise routing, dates of travel and other cruise data (e.g. cruise ships, cruise sailing itineraries, ship details, and cruise pricing information) such as is available from TravTech™. TravTech™ develops and operates web-based travel applications. TravTech™ maintains an on-line application that provides both front and back-office customer management functionality and provides both consumer and travel agents the capability to search and book cruises on-line. Travelers book activities only within the envelope of a specific cruise. That is, a traveler must first select a specific cruise and then activity information corresponding to the cruise is made available to the traveler. There was no capability for identifying a cruise based on a data set of the user's personal, preferred excursion or activity criteria. Also, there was no capability of booking a cruise that the traveler has identified on the basis of the same search results and without additional steps in the process.

In the example of the preferred embodiment of the presently disclosed invention, cruise sailing data such as is available from TravTech™ may be updated on a frequent basis such as daily. Similarly, excursion or activity data such as is available from Shorefox™ also may be updated frequently (e.g. daily). Shorefox™ is mobile app through which a user can investigate the content and availability of shore excursions and elect to book such excursions independently of any particular cruise line or other intermediary. In this way, the search result is based on the latest excursion or activity information available. This avoids reservation conflicts that could otherwise arise due to unintentional overbooking and schedule conflicts between alternative excursion or activity choices.

According to the presently disclosed method, the user may book an activity via an application program interface (“API”) call to Shorefox™—that is, by making a call to the Shorefox™ server in the name of the application using an application program interface. This affords added security to protect the booking information. Preferably, the API is powered by Stripe to facilitate credit card information and allow the user to make an activity reservation from the same website at which the search result was reported. Also according to the presently disclosed method and system, the user may book a cruise the on a third party website such as, for example, the Cruise.com website.

### Travel Plan

The presently disclosed invention includes a travel plan by which users may register for, and login to, the website in order to create a personal profile that identifies their travel interests and preferences. The users can also save their profile, specific search terms, and/or search results for future reference. Users also can save itinerary and activity information about specific cruises that they have reserved or booked in the past. Also, a user may choose to invite third parties to a private group to share information about specific cruises and specific activities. In that case, each member of such a private group may be enabled to view those activities that were purchased on a specific cruise. In this way, the private group can coordinate bookings with each other from anywhere in the world.

The user's travel plan or personal profile may also be accorded loyalty consideration or recognition in response to social media postings (such as photos and comments) related to cruises or activities that they have scheduled or experienced or in which they have demonstrated an interest.

As previously stated, the forgoing features and advantages that are described herein for the example of sea travel according to the presently preferred embodiment also apply to examples wherein the primary mode or travel is by air or land modes. The presently disclosed invention includes such features and advantages in connection with all such transportation modes.

Various versions, modifications and improvements of the presently disclosed invention such as will be apparent to those skilled in the art are included in the scope of the following claims.

We claim:

1. A method for identifying activities based on geographic region, said method comprising the steps of:
a. inputting command signals to a user interface to cause said user interface to generate output signals;
b. transmitting the output signals that are generated by said user interface to a computer, said computer being configured to generate query signals in response to the output signals that are transmitted from said user interface;
c. communicating said query signals that are generated by said computer to a first database wherein said first database maintains data that defines an assortment of activities that are categorized according to at least one of;
i. the respective geographical location where such activities occur,
ii. a time schedule for such activities, and
iii. a category that corresponds to a class of such activities,
said first database being responsive to the query signals from said computer to provide activity data that corresponds to particular activities according to at least one of;
i. the geographical location where such activities occur,
ii. a time schedule for such activities, and
iii. a category that corresponds to a class of such activities;
d. transmitting the activity data provided by said first database to said computer, said computer being further configured to generate cruise query signals in accordance with said activity data that is transmitted to said computer from said first database;
e. communicating cruise query signals from said computer to a second database wherein said second database maintains data that identifies cruises according to at least one of,
i. the respective geographical itinerary for said cruise, and
ii. the time schedule for said cruise,
said second database being configured to identify cruise data in response to said cruise query signals that are communicated from said computer to said second database,
f. transmitting said cruise data identified by said second database to said computer, said computer being further configured to generate correlation signals that represent a measure of correlation between,
i. one or more categories of activities that correspond to activity data from said first database, and
ii. one or more cruises that correspond to cruise data from said second database; and
g. transmitting said correlation signals from said computer to a user display, said user display being configured to display concurrence between activities and cruises in accordance with said correlation signals from said computer.

2. The method of claim 1 wherein said computer is configured to measure the degree of correlation between said activities corresponding to said activity data from said first database and said cruises corresponding to said cruise data from said second database and wherein said user display is responsive to indicate the degree of said correlation.

3. The method of claim 2 wherein said computer is configured to:
a. exclude cruise data for cruises that do not have at least one activity that corresponds to said activity data;
b. identify from cruise data that is not excluded the number of incidents where a cruise itinerary coincides with the location of an activity that corresponds to said activity data;
c. weight each identified cruise in proportion to the number of ports-of-call multiplied by the number of activity categories that the activity data identifies;
d. determine the number of instances when at least one activity in a category that the activity data identifies coincides with a port-of-call of the non-excluded cruise data; and
e. produce an activity match score by dividing the number of instances by the weighted value of that cruise.

4. The method of claim 3 wherein said activity match score is not greater than one.

5. The method of claim 3 wherein said results are displayed in descending order.

6. The method of claim 2 wherein said display includes a bar chart that corresponds to the activity match score.

7. The method of claim 6 wherein said display is rounded to the nearest tenth.
